(19) United States
(12) Patent Application Publication
(10) Pub. No.: US 2022/0395355 A1
(43) Pub. Date: Dec. 15, 2022

(54) DENTAL ALIGNERS

(71) Applicants: Danqing Xia, Brentwood, TN (US); Shawn Prevoir, Northborough, MA (US)

(72) Inventors: Danqing Xia, Brentwood, TN (US); Shawn Prevoir, Northborough, MA (US)

(21) Appl. No.: 17/845,132

(22) Filed: Jun. 21, 2022

Related U.S. Application Data
(60) Provisional application No. 63/177,963, filed on Apr. 22, 2021.

(51) Int. Cl. A61C 7/08; B32B 3/30; B32B 25/20; B32B 25/08; B32B 27/36; B32B 27/32; B32B 27/30; B32B 27/40; B32B 27/34

(52) U.S. Cl. CPC A61C 7/08; B32B 3/30; B32B 25/20; B32B 25/08; B32B 27/36; B32B 27/32; B32B 27/306; B32B 27/40; B32B 27/34; B32B 27/308; B32B 27/365; B32B 27/302; B32B 2274/00; B32B 2250/24; B32B 2307/732; B32B 2307/536; B32B 2307/546; B32B 2307/558; B32B 2307/412; B32B 2535/00; B32B 37/1018

(57) ABSTRACT

Disclosed herein are thermoplastic and thermoset composite materials, which may be used to generate dental appliances such as dental aligners, and methods of preparation and manufacture.

### CLAIM OF PRIORITY

This application claims the benefit of U.S. Provisional Application No. 63/177,963, filed on Apr. 22, 2021, which is incorporated herein by reference in its entirety.

### TECHNICAL FIELD

This disclosure generally relates to methods of preparing thermoplastic and thermoset composite materials and their manufacturing processes to generate dental appliances, such as dental aligners.

### BACKGROUND

Orthodontists move a patient's teeth to their correct position to optimize function and aesthetics. Historically, dental braces, which consist of metal anchors affixed to the teeth and a tensioning wire connecting them, are most common. Dental braces work by providing a continual force to the teeth, gradually urging them to their intended position. These devices are applied, adjusted and maintained by a practitioner over the course of numerous clinical visits.

More recently, alternatives to conventional orthodontic treatment with traditional labial fixed appliances (e.g., dental braces) have become available. One such alternative are dental aligners, which are fabricated from clear plastics. These aligners have been increasingly popular due to the cost and aesthetic benefit compared to labial fixed appliances. Such systems have been commercialized by Align Technology, Inc., San Jose, Calif., under the trade name Invisalign® System. The Invisalign® System is described in numerous patents and patent applications assigned to Align Technology, Inc. including, for example, U.S. Pat. Nos. 6,450,807, 5,975,893, and 9,655,693, as well as on the company's website (“www.invisalign.com”).

Aligner systems consist of a series of aligner shells, each having a plurality of teeth receiving cavities shaped in them capable of applying a repositioning force to the patient's teeth. The shape of the aligner shell and number of aligner shells is determined through the aid of a 3D design tool/predictive mathematical model and practitioner observations. According to the model, each aligner shell needs to be worn for more than 22 hours a day for approximately 2 weeks before another aligner shell of a slightly different shape is used. This process is repeated for 1-2 or more years until optimal teeth placement is achieved.

The number of aligner shells needed, and their frequency of replacement is governed by several factors.

The aligners are made from thin brittle clear thermoplastic resin, typically thermoformed into the desired shape. The donning and doffing of the aligners is difficult, particularly for new users, and often requires flexing and stretching of the shell. This can lead to cracking of the shell, leading to premature aligner replacements.

Due to the nature of polymeric materials, stress relaxation occurs in response to the constant strain placed on the material. As a result, the force exerted on the tooth changes with time, making tooth movement less predictable. Frequent visits with the practitioner are needed to ensure the patient is tracking to the predictive model. Model modification and additional aligners are often needed over the course of the treatment as a result.

Patients may not adhere to the prescribed wear times set out as part of the predictive model due to tooth and gum soreness and pain from the aligners. Because the aligners are not permanently attached to the patient's teeth, the aligners can easily be removed to alleviate pain and soreness, creating interruption in the treatment plan.

The aligners are easily stained by food and drink, such as mustard, coffee, soda, and wine. As a result, they need to be removed during eating and teeth need to be cleaned before re-donning. If this does not occur, food can stick to the aligners, leading to bacteria growth. Bacteria could affect teeth and gum health, leading to unpleasant breath and build-up plaque on the aligners, making plaque more visually apparent in the patient's mouth.

Current aligner materials are typically made by thermoforming polyester, copolyester, polycarbonate, thermoplastic polyurethane elastomer, polypropylene, polyethylene, ethylene-vinyl acetate, etc. extruded sheets. In thermoforming, extruded plastic sheets are heated to a pliable forming temperature, and then either forced over a female tool using a plug, air, or pulled into a female cavity with vacuum to form a specific shape (FIG. 1). The shape is trimmed to create a usable product. The thermoforming process is fast and economical, utilizing inexpensive tooling and allowing for recycling of flash/scrap.

The materials commonly used in thermoforming are amorphous or semi-crystalline in nature. When a constant stress is applied, the polymer chains in the amorphous region of the thermoplastic tend to uncoil and begin to slip past each other. With increased chain mobility, the force exerted by the polymer on the tooth continues to relieve over time, reducing the predictability of tooth movement. Since the material is immersed in saliva, water molecules play a role as a plasticizer, which further reduces the modulus as the polymer continues to swell. Aligner sheet manufacturers tend to use high stiffness materials to accommodate for the creep behavior, which may lead to premature cracking of the aligners, donning and doffing issues, and makes patients suffer from tooth pain and soreness due to the excessively high initial forces.

Attempts to increase the crystallinity region can be considered to improve the creep and water resistance, but may result in higher melting points, making the material more difficult and costly to process. Donning and doffing may also be compromised. To improve creep resistance and toughness, Bay Materials LLC designed a dual shell material by incorporating an elastomeric core between two hard layers in order to improve the elastic range, which is described in U.S. Pat. No. 10,549,511. However, the elastomer middle layer is a soft polymer, which offers more free volume for water and stain absorption. Even though the material can demonstrate a reduced initial force, the gap between the initial and relaxed force is still significant enough for patients to experience discomfort and the change in force over time.

Thermoset materials, where covalent bonds are used to tie together polymer chains, can reduce polymer creep and water uptake. Unfortunately, these materials cannot be thermoformed. As a result, more complicated processing techniques are required to fabricate aligners using such materials. These processes include injection molding, which is not suitable for generating custom aligners, and additive manufacturing. While additive manufacturing can be used to generate custom, patient-specific aligners, such as the example described in U.S. Pat. No. 10,647,879, the disadvantages include lengthy printing and post-processing times, and the end part may present unfavorable yellow appearance, low dimensional accuracy from shrinkage and poor mechanical properties.

There is a need for shell aligner materials that are tougher than existing offerings, can produce more continuous and predictable force to the teeth, mitigate patient pain during wearing, and remain transparent and easy to clean.

### BRIEF SUMMARY OF THE INVENTION

The present disclosure provides alternative materials and the manufacturing methods to address the deficiencies in the materials used for dental appliances used for positioning a patient's teeth. Provided herein is a dental appliance constructed from an extruded plastic sheet. The sheet can be constructed by one or more layers composed of a thermoplastic material having modulus of elasticity between about 500 MPa to about 2500 MPa, which may be cross-linked during or post thermoforming using irradiation techniques, chemical agents, and/or UV light. The effect is to interconnect the chains and reduce the mobility and free volume, which helps to improve the creep resistance and water resistance, without requiring complex processing techniques. To further improve patient comfort, one or more of the materials the sheet is constructed from is/are loaded with an active pharmaceutical ingredient (API), such as a pain management agent, which achieves sustained release of the agent over time. The active pharmaceutical ingredient may also demonstrate good antimicrobial effect for aligner hygiene and freshness of breath.

### BRIEF DESCRIPTION OF THE DRAWINGS

FIG. 1 shows the thermoforming process, where extruded plastic sheets are heated to a pliable forming temperature, then either forced over a female tool using a plug or air, or pulled into a female cavity with vacuum to form a specific shape.

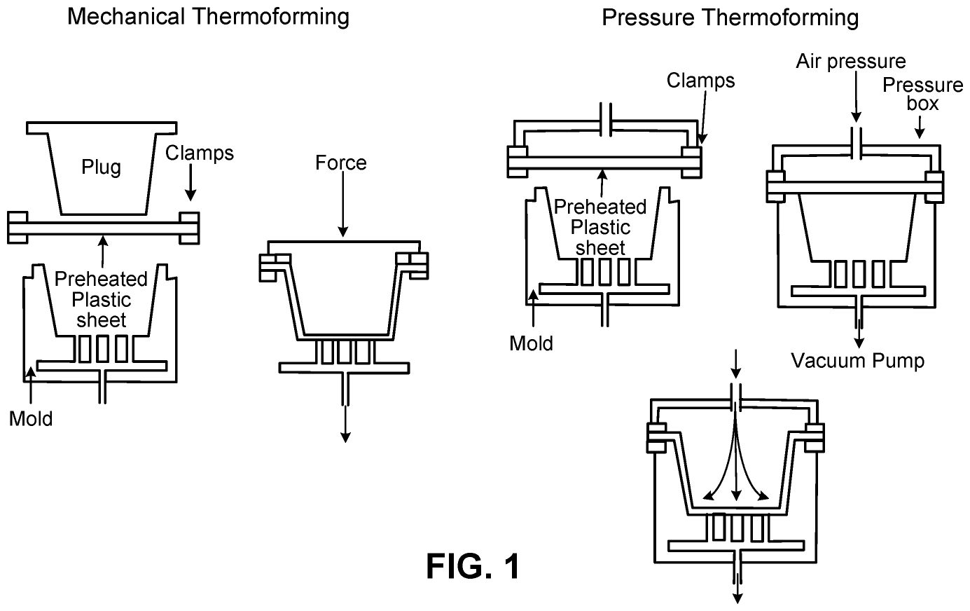

FIG. 2 shows a cross-section view of arrangement of polymer laminate layers in a sheet with a simple A, AB, ABC, ABCD . . . construction. In the multilayer designs, layer A, B, C, D . . . may be the same or different thermoformable materials. Each layer may be composed of one or more thermoformable materials. Each thermoformable layer may or may not be cross-linked by radiation. Each layer may or may not be incorporated with an API.

FIG. 3A depicts a method of the present invention employing residual unsaturated bonds or free radicals to connect chains in the thermoplastic material in situ with high-energy radiation.

FIG. 3B depicts a method of the present invention employing a cross-linker, and/or an initiator, and/or a peroxide to connect chains in the thermoplastic material, with or without radiation.

FIG. 4 depicts a cross-section view of design of a layer incorporated with an API.

FIG. 5 is a simplified block diagram illustrating a method for fabricating a dental appliance.

### DETAILED DESCRIPTION

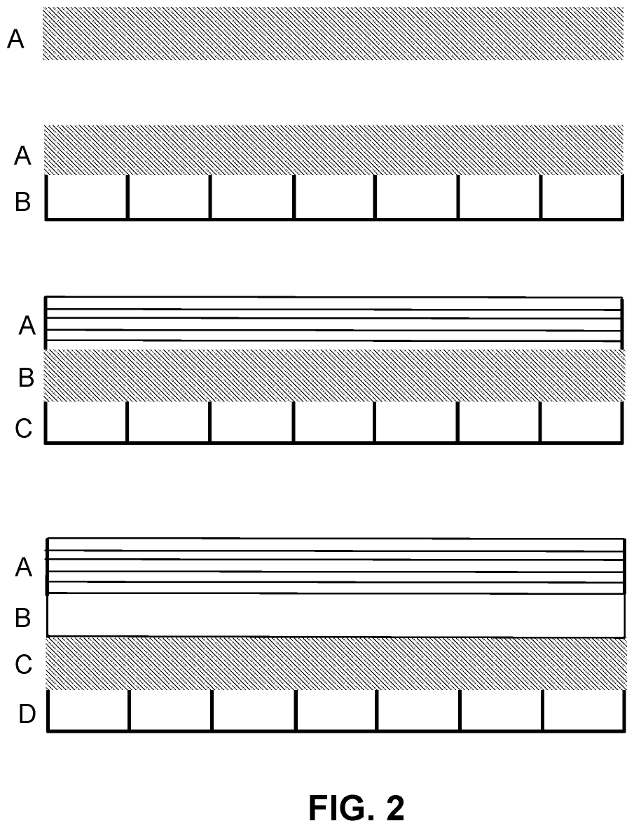

Aligner shells made from a single material or a composite structure consisting of two or more materials need to be optically or close to optically clear for aesthetic purposes (FIG. 2). In some embodiments, the aligner shells are made from a single material or a composite structure consisting of two or more materials having greater than or equal to about 75% transparency.

In some embodiments, the aligner shells are made from a single material or a composite structure consisting of two or more materials which are stiff, yet flexible for donning and doffing. In some embodiments, the aligner shells are made from a single material or a composite structure consisting of two or more materials having a flexural modulus greater than or equal to about 100 MPa to about 3000 MPa. In some embodiments, the aligner shells are made from a single material or a composite structure consisting of two or more materials having a percent elongation at break greater than or equal to about 50%. In some embodiments, the aligner shells are made from a single material or a composite structure consisting of two or more materials having a flexural modulus greater than or equal to about 100 MPa to about 3000 MPa and a percent elongation at break greater than or equal to about 50%.

In some embodiments, the aligner shells are made from a single material or a composite structure consisting of two or more materials selected from, but not limited to, polyesters, copolyester, polyurethanes, polyamides, polyolefins, polyolefin copolymers, acrylic polymers, polycarbonate, and silicones, as well as co-polymers, multi-block copolymers, or blends of two or more of the above are suitable. In some embodiments, the aligner shells are made from a single material or a composite structure consisting of two or more materials selected from BESNO MED, Rilsan clear G850 RNEW, Rilsan G820 RNEW, etc. from Arkema; Tritan FX200, Tritan MX710, Tritan MX810, Tritan TX1001, Eastar MB002, Eastar 6763, etc. from Eastman Chemical; Isoplast 2530, Isoplast 2531, Pellethane 2363, Tecoflex EG, Carbothane PC, etc. from Lubrizol; WHT-M864H, WHT-M875H, WHT-M882H, etc. from Wanhua; Texin RxT76D, Texin RxS292, Texin RxT80A, etc. from Covestro.

Radiation chemistry such as electron-beam (E-beam) and gamma-ray irradiation are known to cross-link polymeric materials such as polyethylene, ethylene vinyl acetate, polyvinyl chloride, and others for electrical wire coatings, shrink-wrap tubing, and battery separators. E-beam is the most commonly used source in radiation chemistry. A detailed description of the E-beam can be found in the literature (Kashiwagi, M. and Hoshi, Y. Electron Beam Processing System and Its Application, SEI Technical Review, 47-53 (75), 2012). E-beam generates free radicals in the polymer, allowing them to form covalent bonds with adjacent polymer chains. Similarly, exposure to certain wavelengths of light in the UV spectrum or peroxides can also generate free radicals in polymers, allowing them to form covalent bonds with adjacent polymer chains.

In some embodiments, the cross-linkable thermoplastic material may be comprised of polyesters, copolyester, polyurethanes, polyamides, polyolefins, polyolefin copolymers, acrylic polymers, polycarbonate, and silicones, as well as co-polymers, multi-block copolymers, or blends of two or more of the above.

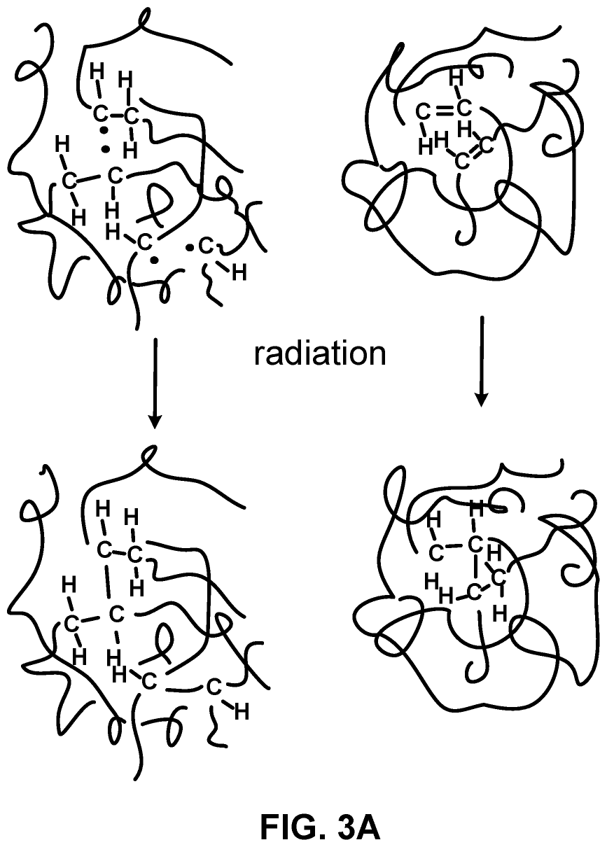

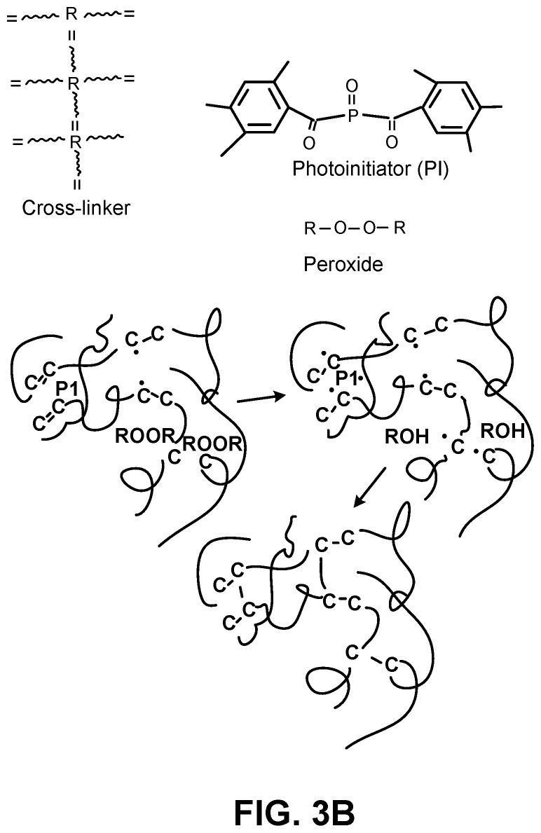

In some embodiments, cross-linking of the thermoplastic material is achieved with residual unsaturated bonds or free radicals in situ using high-energy radiation. In some embodiments, the cross-linking of the thermoplastic material is achieved with residual unsaturated bonds using high-energy radiation. In some embodiments, the cross-linking of the thermoplastic material is achieved with free radicals in situ using high-energy radiation. In some embodiments, the high-energy radiation is ultraviolet (UV) light, E-beam, gamma radiation, or combinations thereof (FIG. 3A).

In some embodiments, the aligner shells are made from a thermoplastic resin. In some embodiments, the thermoplastic resin may be hot compounded with a cross-linker (also called a cross-linking promoter, or a binder), an initiator, and/or a catalyst at a processing temperature at least greater than the glass transition temperature and/or the melting temperature of the thermoplastic resin that can be activated to cross-link by high-energy radiation (FIG. 3B).

In some embodiments, the cross-linker can be a peroxide, amine, a (meth)acrylate monomer, or a vinyl.

In some embodiments, an initiator such as a peroxide, an acryloximino ester, a phosphine oxide, an anthraquinone, a benzoylformate ester, or a catalyst may be required to promote the cross-linking process. In some embodiments, the catalyst is toluene sulfonic acid, dodecylbenzene sulfonic acid, oxalic acid, maleic acid, hexamic acid, or a metal salt.

In some embodiments, the thermoplastic resin may be extruded to a sheet with thickness between about 0.5 mm to about 2 mm, and the sheet may be thermoformed over a positive teeth impression mold into an aligner at a temperature that is at least greater than the glass transition temperature and/or the melting point of the thermoplastic resin.

In some embodiments, the thermoplastic resin may be compounded with about 1 wt % of trimethylolpropane triacrylate, thermoformed, and exposed to E-beam dosages ranging from about 5 MR to about 50 MR to form a dental appliance. In some embodiments, the thermoplastic resin compounded with about 1 wt % benzoyl peroxide may be thermoformed then exposed to light with wavelength ranging from about 350 nm to about 450 nm for about 10 min to about 60 min to form a dental appliance.

In some embodiments, cross-linking may be performed after the aligner is thermoformed from the extruded sheet. In some embodiments, cross-linking may be performed while the aligner is being thermoformed from the extruded sheet. In some embodiments, cross-linking may be performed while the aligner is being thermoformed from the extruded sheet using a clear positive teeth impression tool outfitted with a light source.

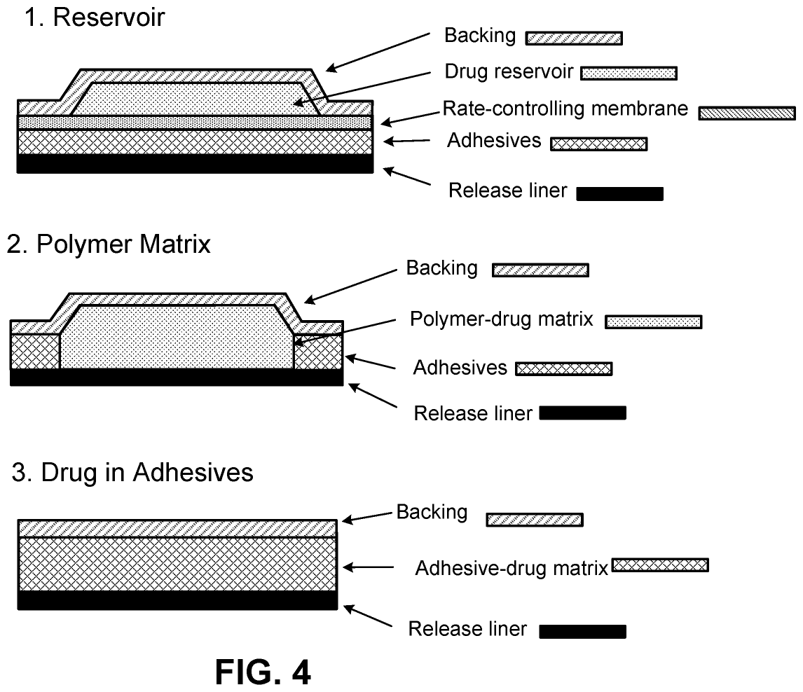

In some embodiments, an active pharmaceutical ingredient (API), either naturally occurring or synthetically derived, may be incorporated into the single material or the composite structure consisting of two or more thermoplastic materials. In some embodiments, the single material may contain a cross-linker. In some embodiments, the single material does not contain a cross-linker. In some embodiments, the API may slowly diffuse out from the polymeric matrix over time, releasing the API to the patient, as illustrated in FIG. 4. In some embodiments, the API may be selected from capsaicin, lidocaine, salicylic acid, scopolamine, diclofenac epolamin, eugenol, or fentanyl.

In some embodiments, the API is hot compounded into the thermoplastic resin between about 0.1 wt % and about 40 wt % when the API is thermally stable. In some embodiments, the API is loaded into the thermoplastic resin by solvent casting. In some embodiments, the API is loaded into the material thermoplastic resin by swelling the polymer with API in compatible solvents.

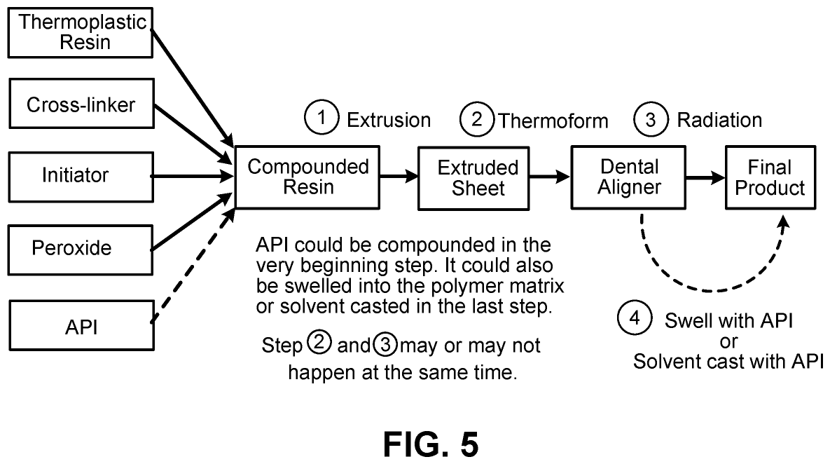

In some embodiments, an agent that freshens breath and/or mitigates bacterial and plaque build-up may be used. In some embodiments, the agent that freshens breath and/or mitigates bacterial and plaque build-up may be hot compounded into the single material or the composite structure consisting of two or more materials. In some embodiments, the single material contains the cross-linker and the API. In some embodiments, the single material does not contain the cross-linker and the API. In some embodiments, the agent that freshens breath and/or mitigates bacterial and plaque build-up may also be the API. In some embodiments, the agent that freshens breath and/or mitigates bacterial and plaque build-up slowly diffuses from the polymeric matrix over time, releasing the agent that freshens breath and/or mitigates bacterial and plaque build-up to the patient. In some embodiments, the agent that freshens breath and/or mitigates bacterial and plaque build-up may be, but is not limited to, peppermint oil, clove, tea tree oil, menthol, or combinations thereof. In some embodiments, the agent that freshens breath and/or mitigates bacterial and plaque build-up are compounded into the material between about 0.1 wt % and about 40 wt % (FIG. 5).

In some embodiments, the multilayer material may be fabricated by a number of methods including, but not limited to, hot or cold lamination, adhesive lamination, melt lamination, coextrusion, and other known methods.

Embodiment 1. An orthodontic appliance for repositioning a patient's teeth, the appliance comprising:
a shell having a plurality of teeth receiving cavities shaped to apply a repositioning force to the patient's teeth, wherein the shell is a material configured to reduce degradation of the repositioning force over time when the shell is worn on the patient's teeth, the material comprising:
   a single material, comprising a thermoplastic with a thickness of about 250 μm to about 2000 μm, which has been cross-linked during or after the thermoforming process of the aligner over a female tool.

Embodiment 2. The appliance of any one of the embodiments described herein, wherein the single material is a polyester, a copolyester, a polyethylene, an ethylene vinyl acetate, a polyurethane, a polyamide, a polyolefin, a polyolefin copolymer, an acrylic polymer, a polycarbonate, or a co-polymer cross-linked with an electron-beam.

Embodiment 3. The appliance of any one of the embodiments described herein, wherein the single material is Tritan TX1001, a polyamide 11 from Eastman Chemical with a Rockwell R Hardness of 112 and tensile modulus of 1.5 GPa.

Embodiment 4. The appliance of any one of the embodiments described herein, wherein the single material is a polyester, a copolyester, a polyethylene, an ethylene vinyl acetate, a polyurethane, a polyamide, a polyolefin, a polyolefin copolymer, acrylic polymer, polycarbonate, or co-polymer compounded with about 0.1 wt/o to about 10 wt % of a cross-linker.

Embodiment 5. The appliance of any one of the embodiments described herein, wherein the cross-linker has a di, tri, or quatro functionality.

Embodiment 6. The appliance of any one of the embodiments described herein, wherein the cross-linker is trimethylolpropane triacrylate.

Embodiment 7. The appliance of any one of the embodiments described herein, where the cross-linker is neopentyl glycol dimethacrylate, ethylene glycol dimethacrylate, 1,3-butylene dimethacrylate, 1,4-butanediol dimethacrylate, diethylene glycol dimethacrylate, triethylene glycol dimethacrylate, tricyclodecane dimethanol dimethacrylate, or ethoxylated bisphenol-A dimethacrylate.

Embodiment 8. The appliance of any one of the embodiments described herein, where the cross-linker is a photoinitiator selected from a benzophenone, a benzil ketal, a hydroxyacetophenone, aminoacetophenone, a phosphine oxide, a benzophenone, a benzyl formate, or a thioxanthone.

Embodiment 9. The appliance of any one of the embodiments described herein, wherein the cross-linker is activated by E-beam.

Embodiment 10. The appliance of any one of the embodiments described herein, wherein the cross-linker is activated by UV light.

Embodiment 11. The appliance of any one of the embodiments described herein, wherein the material has:
a hardness of about 80 A to about 90 D;
a flexural modulus between about 1000 MPa to about 2500 MPa;
an impact resistance equal to or greater than about 40 J/m by IZOD notched impact testing;
an elongation at break greater than about 50%; and
a light transmission between about 400 nm and about 800 nm greater than about 75%.

Embodiment 12. An orthodontic appliance for repositioning a patient's teeth, the appliance comprising:
a shell having a plurality of teeth receiving cavities shaped to apply a repositioning force to the patient's teeth, wherein the shell is a material configured to reduce degradation of the repositioning force over time when the shell is worn on the patient's teeth, the material comprising:
   a multi-material laminate having one or more layers of materials, wherein one or more layers of materials is a hard material comprised of a cross-linkable thermoplastic, and one or more layers of materials is a soft polymer comprised of a cross-linkable thermoplastic elastomer, with a combined thickness from about 250 μm to about 2000 μm which has been cross-linked during or after the thermoforming process of the aligner.

Embodiment 13. The appliance of any one of the embodiments described herein, wherein the hard material is a polyester, a copolyester, a polyurethane, a polyamide, a polyolefin, a polyolefin copolymer, an acrylic polymer, a polycarbonate, or a co-polymer cross-linked with an E-beam.

Embodiment 14. The appliance of any one of the embodiments described herein, wherein the hard material is a polyester, a copolyester, a polyurethane, a polyamide, a polyolefin, a polyolefin copolymer, an acrylic polymer, a polycarbonate, or a co-polymer compounded with about 0.1% to about 10 wt % of a cross-linker.

Embodiment 15. The appliance of any one of the embodiments described herein, wherein the cross-linker has a di, tri, or quatro functionality.

Embodiment 16. The appliance of any one of the embodiments described herein, wherein the cross-linker is trimethylolpropane triacrylate.

Embodiment 17. The appliance of any one of the embodiments described herein, where the cross-linker is neopentyl glycol dimethacrylate, ethylene glycol dimethacrylate, 1,3-butylene dimethacrylate, 1,4 butanediol dimethacrylate, diethylene glycol dimethacrylate, triethylene glycol dimethacrylate, tricyclodecane dimethanol dimethacrylate, or ethoxylated bisphenol-A dimethacrylate.

Embodiment 18. The appliance of any one of the embodiments described herein, where the cross-linker is a photoinitiator selected from a benzophenone, a benzil ketal, a hydroxyacetophenone, an aminoacetophenone, a phosphine oxide, a benzophenone, a benzyl formate, and a thioxanthone.

Embodiment 19. The appliance of any one of the embodiments described herein, wherein the cross-linker is activated by E-beam.

Embodiment 20. The appliance of any one of the embodiments described herein, wherein the cross-linker is activated by UV light.

Embodiment 21. The appliance of any one of the embodiments described herein, wherein the hard material has:
a hardness of about 80 A to about 90 D;
an elongation at break greater than 50%;
a flexural modulus between about 1000 MPa to about 2500 MPa; and
a light transmission between about 400 nm and about 800 nm greater than about 75%.

Embodiment 22. The appliance of any one of the embodiments described herein, wherein the soft material is a thermoplastic polyurethane elastomer, a styrenic-based thermoplastic elastomer, a copolyester thermoplastic elastomer, a polyamide elastomer, or a silicone cross-linked with an E-beam.

Embodiment 23. The appliance of any one of the embodiments described herein, wherein the soft material is a thermoplastic polyurethane elastomer, a styrenic-based thermoplastic elastomer, a copolyester thermoplastic elastomer, a polyamide elastomer polyolefin, or a silicone compounded with about 0.1 wt % to about 10 wt % of a cross-linker.

Embodiment 24. The appliance of any one of the embodiments described herein, wherein the cross-linker has a di, tri, or quatro functionality.

Embodiment 25. The appliance of any one of the embodiments described herein, wherein the cross-linker is trimethylolpropane triacrylate.

Embodiment 26. The appliance of any one of the embodiments described herein, where the cross-linker is neopentyl glycol dimethacrylate, ethylene glycol dimethacrylate, 1,3-butylene dimethacrylate, 1,4 butanediol dimethacrylate, diethylene glycol dimethacrylate, triethylene glycol dimethacrylate, tricyclodecane dimethanol dimethacrylate, or ethoxylated bisphenol-A dimethacrylate.

Embodiment 27. The appliance of any one of the embodiments described herein, where the cross-linker is a photoinitiator selected from a benzophenone, a benzil ketal, a hydroxyacetophenone, an aminoacetophenone, a phosphine oxide, a benzophenone, a benzyl formate, and a thioxanthone.

Embodiment 28. The appliance of any one of the embodiments described herein, wherein the cross-linker is activated by E-beam.

Embodiment 29. The appliance of any one of the embodiments described herein, wherein the cross-linker is activated by UV light.

Embodiment 30. The appliance of any one of the embodiments described herein, wherein the soft material has:
a hardness of about 50 A to about 90 A;
an elongation at break greater than 100%;
a flexural modulus between about 5 MPa to about 1000 MPa and
a light transmission between about 400 nm and about 800 nm greater than about 75%.

Embodiment 31. An orthodontic appliance capable of slowly releasing one or more agents to the teeth, gums, and mouth of a patient while reposition the patient's teeth, the appliance comprising:
a shell having a plurality of teeth receiving cavities shaped to apply a repositioning force to the patient's teeth, wherein the shell is a material compounded with an active pharmaceutical ingredient (API) and configured to reduce degradation of the repositioning force over time when the shell is worn on the patient's teeth, the material comprising:
   a single material, where the single material is composed of a thermoplastic containing an API with a thickness of about 250 μm to about 2000 μm.

Embodiment 32. The appliance of any one of the embodiments described herein, wherein the hard material is a polyester, a copolyester, a polyurethane, a polyamide, a polyolefin, a polyolefin copolymer, an acrylic polymer, a polycarbonate, or a co-polymer cross-linked with an E-beam during or after the thermoforming process of the aligner.

Embodiment 33. The appliance of any one of the embodiments described herein, wherein the single material is a polyester, a copolyester, a polyurethane, a polyamide, a polyolefin, a polyolefin copolymer, an acrylic polymer, polycarbonate, or a co-polymer compounded with a cross-linking with about 0.1 wt/o to about 10 wt % of a cross-linker.

Embodiment 34. The appliance of any one of the embodiments described herein, wherein the cross-linker has a di, tri, or quatro functionality.

Embodiment 35. The appliance of any one of the embodiments described herein, wherein the cross-linker is trimethylolpropane triacrylate.

Embodiment 36. The appliance of any one of the embodiments described herein, where the cross-linker is neopentyl glycol dimethacrylate, ethylene glycol dimethacrylate, 1,3-butylene dimethacrylate, 1,4 butanediol dimethacrylate, diethylene glycol dimethacrylate, triethylene glycol dimethacrylate, tricyclodecane dimethanol dimethacrylate, or ethoxylated bisphenol-A dimethacrylate.

Embodiment 37. The appliance of any one of the embodiments described herein, where the cross-linker is a photoinitiator selected from a benzophenone, a benzil ketal, a hydroxyacetophenone, an aminoacetophenone, a phosphine oxide, a benzophenone, a benzyl formate, and a thioxanthone.

Embodiment 38. The appliance of any one of the embodiments described herein, wherein the cross-linker is activated by E-beam.

Embodiment 39. The appliance of any one of the embodiments described herein, wherein the cross-linker is activated by UV light.

Embodiment 40. The appliance of any one of the embodiments described herein, wherein the single material is a polyester, a copolyester, a polyurethane, a polyamide, a polyolefin, a polyolefin copolymer, an acrylic polymer, a polycarbonate, or a co-polymer compounded with an API.

Embodiment 41. The appliance of any one of the embodiments described herein, wherein the API is a numbing agent, wherein the numbing agent numbs the teeth and gums.

Embodiment 42. The appliance of any one of the embodiments described herein, wherein the numbing agent is naturally occurring and is eugenol, novocaine, lidocaine, or a combination thereof.

Embodiment 43. The appliance of any one of the embodiments described herein, wherein the API comprises about 0.1 wt % to about 40 wt % of the composition.

Embodiment 44. The appliance of any one of the embodiments described herein, wherein the API freshens the breath of the patient.

Embodiment 45. The appliance of any one of the embodiments described herein, wherein the API is peppermint oil, clove oil, or menthol present in about 0.1 wt % to about 40 wt % of the composition.

Embodiment 46. The appliance of any one of the embodiments described herein, wherein the material has:
a hardness of about 80 A to about 90 D;
a flexural modulus between about 1000 MPa to about 2500 MPa;
an impact resistance equal to or greater than about 40 J/m by IZOD notched impact testing;
an elongation at break greater than about 50%; and
a light transmission between about 400 nm and about 800 nm greater than about 75%.

Embodiment 47. An orthodontic appliance capable of slowly releasing an agent to the teeth, gums, and mouth of a patient while reposition the patient's teeth, the appliance comprising: a shell having a plurality of teeth receiving cavities shaped to apply a repositioning force to the patient's teeth, wherein the shell is a cross-linkable material compounded with an agent(s) capable of numbing and/or reducing unpleasant breath odor and configured to reduce degradation of the repositioning force over time when the shell is worn on the patient's teeth, the material comprising:
a multi-material laminate comprising one or more layers of materials, wherein one or more layers of materials is a hard material comprised of a thermoplastic, and one or more layers of materials is a soft polymer comprised of a thermoplastic elastomer, wherein the one or more layers have a combined thickness from about 250 μm to about 2000 μm, and one or more layers are compounded with a time-released API.

Embodiment 48. The appliance of any one of the embodiments described herein, wherein the hard material is a polyester, a copolyester, a polyurethane, a polyamide, a polyolefin, a polyolefin copolymer, an acrylic polymer, a polycarbonate, or a co-polymer cross-linked with an E-beam.

Embodiment 49. The appliance of any one of the embodiments described herein, wherein the hard material is a polyester, a copolyester, a polyurethane, a polyamide, a polyolefin, a polyolefin copolymer, an acrylic polymer, a polycarbonate, or a co-polymer compounded with about 0.1 wt % to about 10 wt % of a cross-linker.

Embodiment 50. The appliance of any one of the embodiments described herein, wherein the cross-linker has a di, tri, or quatro functionality.

Embodiment 51. The appliance of any one of the embodiments described herein, wherein the cross-linker is trimethylolpropane triacrylate.

Embodiment 52. The appliance of any one of the embodiments described herein, where the cross-linker is neopentyl glycol dimethacrylate, ethylene glycol dimethacrylate, 1,3-butylene dimethacrylate, 1,4 butanediol dimethacrylate, diethylene glycol dimethacrylate, triethylene glycol dimethacrylate, tricyclodecane dimethanol dimethacrylate, or ethoxylated bisphenol-A dimethacrylate.

Embodiment 53. The appliance of any one of the embodiments described herein, where the cross-linker is a photoinitiator selected from a benzophenone, a benzil ketal, a hydroxyacetophenone, an aminoacetophenone, a phosphine oxide, a benzophenone, a benzyl formate, and a thioxanthone.

Embodiment 54. The appliance of any one of the embodiments described herein, wherein the cross-linker is activated by E-beam.

Embodiment 55. The appliance of any one of the embodiments described herein, wherein the cross-linker is activated by UV light.

Embodiment 56. The appliance of any one of the embodiments described herein, wherein the single material is a polyester, a copolyester, a polyurethane, a polyamide, a polyolefin, a polyolefin copolymer, an acrylic polymer, a polycarbonate, or a co-polymer compounded with an API.

Embodiment 57. The appliance of any one of the embodiments described herein, wherein the API is a numbing agent, wherein the numbing agent numbs the teeth and gums.

Embodiment 58. The appliance of any one of the embodiments described herein, wherein the numbing agent is naturally occurring and is eugenol, novocaine or lidocaine.

Embodiment 59. The appliance of any one of the embodiments described herein, wherein the API comprises about 0.1 wt % to about 40 wt % of the composition.

Embodiment 60. The appliance of any one of the embodiments described herein, wherein the API freshens the breath of the patient.

Embodiment 61. The appliance of any one of the embodiments described herein, wherein the API is present in about 0.1 wt % to about 40 wt % of the composition, wherein the API comprises peppermint oil, clove oil, menthol, or combinations thereof.

Embodiment 62. The appliance of any one of the embodiments described herein, wherein the material has:
a hardness of about 80 A to about 90 D;
a flexural modulus between about 1000 MPa to 2500 MPa;
an impact resistance equal to or greater than about 40 J/m by IZOD notched impact testing;
an elongation at break greater than about 50%; and
a light transmission between about 400 nm and about 800 nm greater than about 75%.

Embodiment 63. The appliance of any one of the embodiments described herein, wherein the soft material is a thermoplastic polyurethane elastomer, a styrenic-based thermoplastic elastomer, a copolyester thermoplastic elastomer, a polyamide elastomer, or a silicone cross-linked with an E-beam.

Embodiment 64. The appliance of any one of the embodiments described herein, wherein the soft material is a thermoplastic polyurethane elastomer, a styrenic-based thermoplastic elastomer, a copolyester thermoplastic elastomer, a polyamide elastomer polyolefin, or a silicone compounded with about 0.1 wt % to about 10 wt % of a cross-linker.

Embodiment 65. The appliance of any one of the embodiments described herein, wherein the cross-linker has a di, tri, or quatro functionality.

Embodiment 66. The appliance of any one of the embodiments described herein, wherein the cross-linker is trimethylolpropane triacrylate.

Embodiment 67. The appliance of any one of the embodiments described herein, where the cross-linker is neopentyl glycol dimethacrylate, ethylene glycol dimethacrylate, 1,3-butylene dimethacrylate, 1,4 butanediol dimethacrylate, diethylene glycol dimethacrylate, triethylene glycol dimethacrylate, tricyclodecane dimethanol dimethacrylate, or ethoxylated bisphenol-A dimethacrylate.

Embodiment 68. The appliance of any one of the embodiments described herein, wherein the cross-linker is a photoinitiator selected from a benzophenone, a benzil ketal, a hydroxyacetophenone, an aminoacetophenone, a phosphine an oxide, a benzophenone, a benzyl formate, and a thioxanthone.

Embodiment 69. The appliance of any one of the embodiments described herein, wherein the cross-linker is activated by E-beam.

Embodiment 70. The appliance of any one of the embodiments described herein, wherein the cross-linker is activated by UV light.

Embodiment 71. The appliance of any one of the embodiments described herein, wherein the single material is a polyester, a copolyester, a polyurethane, a polyamide, a polyolefin, a polyolefin copolymer, an acrylic polymer, a polycarbonate, or co-polymer compounded with an API.

Embodiment 72. The appliance of any one of the embodiments described herein, wherein the API is a numbing agent, wherein the numbing agent numbs the teeth and gums.

Embodiment 73. The appliance of any one of the embodiments described herein, wherein the numbing agent is naturally occurring and is selected from eugenol, novocaine, and lidocaine.

Embodiment 74. The appliance of any one of the embodiments described herein, wherein the API comprises about 0.1 wt % to about 40 wt % of the composition.

Embodiment 75. The appliance of any one of the embodiments described herein, wherein the API freshens the breath of the patient.

Embodiment 76. The appliance of any one of the embodiments described herein, wherein the API is present in about 0.1 wt % to about 40 wt % of the composition, wherein the API comprises peppermint oil, clove oil, menthol, or combinations thereof.

Embodiment 77. The appliance of any one of the embodiments described herein, wherein the soft material has:
a hardness of about 50 A to about 90 A;
an elongation at break greater than about 100%;
a flexural modulus between about 5 MPa to about 1000 MPa; and
a light transmission between about 400 nm and about 800 nm greater than about 75%.

### LIST OF REFERENCES

https://bioplasticsnews.com/2019/05/04/thermoforming-with-biobased-plastics-for-greater-sustainability/.
Kandavilli S, Nair V, and Panchagnula R. Polymers in transdermal drug delivery systems Pharm. Technol. North Am. 2002; 26(5):62.
Ye J, Wang Q, and Chen G. Application of pressure sensitive adhesives in transdermal drug delivery systems Zhongguo Jiaonianji 1996; 5(4):22-25.
Hanumanaik M, Patil U, Kumar G, Patel S K, Singh I, and Jadatkar K. Design, evaluation and recent trends in transdermal drug delivery system: a review Int. J. Pharm. Sci. Res. 2012; 3(8):2393-2406.

Various modifications of the invention, in addition to those described herein, will be apparent to those skilled in the art from the foregoing description. Such modifications are also intended to fall within the scope of the appended claims. Each reference, including without limitation all patent, patent applications, and publications, cited in the present application is incorporated herein by reference in its entirety.

What is claimed is:

1. An orthodontic appliance for repositioning a patient's teeth, the appliance comprising:
a shell having a plurality of teeth receiving cavities shaped to apply a repositioning force to the patient's teeth, wherein the shell is a material configured to reduce degradation of the repositioning force over time when the shell is worn on the patient's teeth, the material comprising:
a single material, comprising a thermoplastic with a thickness of about 250 μm to about 2000 μm, which has been cross-linked during or after the thermoforming process of the aligner over a female tool.

2. The appliance of claim 1, wherein the single material is a polyester, a copolyester, a polyethylene, an ethylene vinyl acetate, a polyurethane, a polyamide, a polyolefin, a polyolefin copolymer, an acrylic polymer, a polycarbonate, or a co-polymer cross-linked with an electron-beam.

3. The appliance of claim 1, wherein the single material is a polyester, a copolyester, a polyethylene, an ethylene vinyl acetate, a polyurethane, a polyamide, a polyolefin, a polyolefin copolymer, acrylic polymer, polycarbonate, or co-polymer compounded with about 0.1 wt % to about 10 wt % of a cross-linker, wherein the cross-linker is activated with an electron-beam or UV light.

4. The appliance of claim 3, wherein the cross-linker is trimethylolpropane triacrylate, neopentyl glycol dimethacrylate, ethylene glycol dimethacrylate, 1,3-butylene dimethacrylate, 1,4-butanediol dimethacrylate, diethylene glycol dimethacrylate, triethylene glycol dimethacrylate, tricyclodecane dimethanol dimethacrylate, or ethoxylated bisphenol-A dimethacrylate, a photoinitiator selected from a benzophenone, a benzil ketal, a hydroxyacetophenone, aminoacetophenone, a phosphine oxide, a benzophenone, a benzyl formate, or a thioxanthone.

5. The appliance of claim 1, wherein the shell is comprised of a material compounded with an active pharmaceutical ingredient (API).

6. The appliance of claim 1, wherein the material has:
a hardness of about 80 A to about 90 D;
a flexural modulus between about 1000 MPa to about 2500 MPa;
an impact resistance equal to or greater than about 40 J/m by IZOD notched impact testing;
an elongation at break greater than about 50%; and
a light transmission between about 400 nm and about 800 nm greater than about 75%.

7. An orthodontic appliance for repositioning a patient's teeth, the appliance comprising:
a shell having a plurality of teeth receiving cavities shaped to apply a repositioning force to the patient's teeth, wherein the shell is a material configured to reduce degradation of the repositioning force over time when the shell is worn on the patient's teeth, the material comprising:
a multi-material laminate having one or more layers of materials, wherein one or more layers of materials is a hard material comprised of a cross-linkable thermoplastic, and one or more layers of materials is a soft polymer comprised of a cross-linkable thermoplastic elastomer, with a combined thickness from about 250 μm to about 2000 μm which has been cross-linked during or after the thermoforming process of the aligner.

8. The appliance of claim 7, wherein the hard material is a polyester, a copolyester, a polyurethane, a polyamide, a polyolefin, a polyolefin copolymer, an acrylic polymer, a polycarbonate, or a co-polymer cross-linked with an electron-beam.

9. The appliance of claim 7, wherein the hard material is a polyester, a copolyester, a polyurethane, a polyamide, a polyolefin, a polyolefin copolymer, an acrylic polymer, a polycarbonate, or a co-polymer compounded with about 0.1% to about 10 wt % of a cross-linker, wherein the cross-linker is activated with an electron-beam or UV light.

10. The appliance of claim 9, wherein the cross-linker is trimethylolpropane triacrylate, neopentyl glycol dimethacrylate, ethylene glycol dimethacrylate, 1,3-butylene dimethacrylate, 1,4 butanediol dimethacrylate, diethylene glycol dimethacrylate, triethylene glycol dimethacrylate, tricyclodecane dimethanol dimethacrylate, or ethoxylated bisphenol-A dimethacrylate, a photoinitiator selected from a benzophenone, a benzil ketal, a hydroxyacetophenone, an aminoacetophenone, a phosphine oxide, a benzophenone, a benzyl formate, and a thioxanthone.

11. The appliance of claim 7, wherein one or more layers of materials are compounded with an active pharmaceutical ingredient (API).

12. The appliance of claim 7, wherein the hard material has:
a hardness of about 80 A to about 90 D;
an elongation at break greater than 50%;
a flexural modulus between about 1000 MPa to about 2500 MPa; and
a light transmission between about 400 nm and about 800 nm greater than about 75%.

13. The appliance of claim 7, wherein the soft material is a thermoplastic polyurethane elastomer, a styrenic-based thermoplastic elastomer, a copolyester thermoplastic elastomer, a polyamide elastomer, or a silicone cross-linked with an electron-beam.

14. The appliance of claim 7, wherein the soft material is a thermoplastic polyurethane elastomer, a styrenic-based thermoplastic elastomer, a copolyester thermoplastic elastomer, a polyamide elastomer polyolefin, or a silicone compounded with about 0.1 wt % to about 10 wt % of a cross-linker, wherein the cross-linker is activated with an electron-beam or UV light.

15. The appliance of claim 14, wherein the cross-linker is trimethylolpropane triacrylate, neopentyl glycol dimethacrylate, ethylene glycol dimethacrylate, 1,3-butylene dimethacrylate, 1,4 butanediol dimethacrylate, diethylene glycol dimethacrylate, triethylene glycol dimethacrylate, tricyclodecane dimethanol dimethacrylate, or ethoxylated bisphenol-A dimethacrylate, a photoinitiator selected from a benzophenone, a benzil ketal, a hydroxyacetophenone, an aminoacetophenone, a phosphine oxide, a benzophenone, a benzyl formate, and a thioxanthone.

16. The appliance of claim 7, wherein the soft material has:
a hardness of about 50 A to about 90 A;
an elongation at break greater than 100%;
a flexural modulus between about 5 MPa to about 1000 MPa; and
a light transmission between about 400 nm and about 800 nm greater than about 75%.

17. The appliance of claim 5, wherein the API is a numbing agent, naturally occurring, and is eugenol, novocaine, lidocaine, or a combination thereof, present in about 0.1 wt % to about 40 wt % of the composition.

18. The appliance of claim 11, wherein the API is a numbing agent, naturally occurring, and is eugenol, novocaine, lidocaine, or a combination thereof, present in about 0.1 wt % to about 40 wt % of the composition.

19. The application of claim 5, wherein the API is a breath freshening agent, comprised of peppermint oil, clove oil, menthol, or a combination thereof, present in about 0.1 wt % to about 40 wt % of the composition.

20. The application of claim 11, wherein the API is a breath freshening agent, comprised of peppermint oil, clove oil, menthol, or a combination thereof, present in about 0.1 wt % to about 40 wt % of the composition.
